(19) United States
(12) Patent Application Publication
(10) Pub. No.: US 2016/0124281 A1
(43) Pub. Date: May 5, 2016

(54) Active Liquid-Crystal 3D Glasses

(71) Applicants: Igor Nikolaevich Kompanets, Moscow (RU); Aleksandr Lvovich Andreev, Moscow (RU); Vasily Aleksandrovich Ezhov, Moscow (RU); Aleksandr Georgievich Sobolev, Moscow (RU)

(72) Inventors: Igor Nikolaevich Kompanets, Moscow (RU); Aleksandr Lvovich Andreev, Moscow (RU); Vasily Aleksandrovich Ezhov, Moscow (RU); Aleksandr Georgievich Sobolev, Moscow (RU)

(21) Appl. No.: 13/990,339

(22) PCT Filed: Mar. 10, 2011
(86) PCT No.: PCT/RU2011/000147

§ 371 Date: Dec. 9, 2015

(30) Foreign Application Priority Data
Nov. 29, 2010 (RU) 2010148477

(51) Int. Cl. G02F 1/141; G02B 27/26; G02F 1/1343; G02B 27/22; G02F 1/1335

(52) U.S. Cl. CPC G02F 1/141; G02B 27/2264; G02F 1/133528; G02F 1/13439; G02B 27/26

(57) ABSTRACT

The invention relates to the field of display technology, and can be used in systems for the free-dimensional representation of information. Active liquid-crystal 3D glasses are proposed which comprise a synchronization signal receiver, an independent power source, an electronic driver and two liquid-crystal shutters such that the liquid crystal in the latter is ferroelectric, wherein the boundary conditions for indicated liquid crystal, determined by a square coefficient of the anchoring energy of molecules in the liquid-crystal layer with the boundary surface of a dielectric or orienting coating, are related in a specific manner to the magnitude of the helix pitch and the thickness of the ferroelectric liquid crystal layer. A range is also proposed for selecting the thickness of the ferroelectric liquid-crystal layer and the condition for implementing the dielectric coating, a low-voltage power element and the electronic driver.

This application claims priority to Russian Patent Application Number 2010148477 filed Nov. 29, 2010, and International Application Number PCT/RU2011/000147 filed on Mar. 10, 2011, both applications are incorporated herein in their entirety. The invention relates to the field of optoelectronics and display technology, and can be used in computer and television systems of two-dimensional and three-dimensional information displaying both with standard frame frequency (60-160 Hz), and with high frame frequency (a few kilohertz), for example, in multi-purpose 3D glasses, projection-type three-dimensional displays of LCOS-type, as well as in displays of mobile devices (cell phones, smart phones, communicators).

### PRIOR ART

The advantage of stereoscopic (3D) displays with the use of active 3D glasses (hereinafter 3D glasses) is the implementation of full screen resolution in observed three-dimensional image at the absence of restrictions for observers quantity and for their position relatively to screen, what is till now unachievable almost for all types of existing glasses-free (autostereoscopic) displays.

Every optical shutter of 3D glasses is required to provide sufficiently short reaction time τᵣₑₗₐₓ in order to avoid crosstalk between images of different aspect angles of 3D scene replacing each other on the screen, and sufficiently short relaxation time τᵣₑₗₐₓ in order to avoid brightness spurious gradient along the scanning direction in every specified image. For present-day 3D displays operating with standard frame frequencies up to 120-160 Hz every specified switching time of optical shutter should not exceed 1-2 ms, because standard time interval τᵢₙₜ between neighbouring frames is about 1 ms (determined as the flyback time of image scan in CRT).

Besides response speed, it is reasonable to keep in mind the possible lowest amplitude of the optical shutter electric control voltage in order to minimize the energy of switching of pair of optical shutters and thus to extend to the utmost the operational life of the battery in wireless 3D glasses.

Conventionally in optical shutters of 3D glasses and as elements in liquid-crystal (LC) screens the light-modulating cells on the basis of nematic liquid crystals (NLC) are used.

There are known active liquid-crystal 3D glasses [1] containing synchronization signal receiver, self-contained power supply, electronic driver and two NLC shutters, electrical inputs, first and second of which are connected to first and second outputs of electronic driver, which input is connected to the synchronization signal receiver output, and self-contained power supply is made as a single battery and stabilized voltage up-converter, herewith the output of a single battery is connected to input of stabilized voltage up-converter, and the output of a single battery is first output of self-contained power supply and is connected with power output of synchronization signal receiver, and output of stabilized voltage up-converter is the second output of self-contained power supply and is connected with power output of electronic driver, and every LC shutter is made as sequentially optically coupled first linear polarizer, first transparent dielectric plate, NLC layer, second transparent dielectric plate and second linear polarizer, the internal sides of the first and second transparent dielectric plates are coated with the first and second transparent electrodes, over which first and second transparent orienting anisotropic coatings are deposited, at least over one of which transparent dielectric coating is deposited, and NLC layer is made as π—structure with the possibility of electrically inducted change n of its birefringence.

In 3D glasses known by now the basis for optical shutters is either π-structure in NLC layer (angle φ=0), or supertwisted structure in NLC layer (angle φ=270⁰), where φ is the angle between first and second NLC directors on first and second boundary surfaces of NLC layer adjacent to the surfaces of first and second dielectric (anisotropic) coatings, respectively. This is due to achieved in such structures minimum value of τᵣₑₗₐₓ among all NLC-structures [2]. NLC π-structure is characterized with reaction time τ_{react}^{NLC} , of about 0.3 ms at 20V of alternating-sign control voltage (±20V) and relaxation time τᵣₑₗₐₓ^{NLC} of about 3 ms. For φ=270⁰ (supertwisted cell) control voltage is reduced to ±12 V, and relaxation time rᵣₑₗₐₓ^{NLC} amounts about 2 ms at keeping the same reaction time. In both specified NLC-structures the relaxation time τᵣₑₗₐₓ^{NLC} if does not depend on the value of control voltage (depends on the NLC layer thickness d).

Limiting natural frequency of 3D glasses switching is determined with the sum of reaction time τ_{react}^{NLC} and relaxation time τᵣₑₗₐₓ^{NLC}, and amounts not more than 300 Hz without regard to time needed for scanning of observed stereo image. In actual practice the stereo image frame frequency at observation by means of known 3D glasses with NLC-shutters does not exceed 120-160 Hz.

The greater is frame frequency, not only the less stereo image flickering is seen, but the better (more correct) the dynamics of observed 3D scenes is reproduced, as far as in this case every eye receives information from the screen alternatively with the other eye (through alternatively switched shutters of 3D glasses), i.e. time interval of information absence for every eye is 2 times longer than at observation of ordinary (monoscopic) image. I.e. for obtaining the equally correct perception of observed scenes dynamics the frame frequency of stereo image should be two times higher than the frame frequency of monoscopic image. As far as standard frame frequency of monoscopic displays has already achieved the value of 120 Hz, standard frame frequency of stereoscopic images should be not less than 240 Hz, for example, in the context of the same reproduction quality of 3D scene dynamics.

In order to reduce flickering the methods [2-4] are proposed to increase the frequency (up to 240-480 Hz) of the light flux arrival at the expense of illumination spatial modulation in LC displays (what is being an analogue of optical obturation during movie screening). They lead to reduction of flickering, however along with it the real frequency of information updating at screen (real frame frequency) remains the same that does not allow simultaneous increasing the smoothness of dynamic scenes reproduction.

New advanced technology of time sequential colour at a display screen that makes possible the obtaining of brighter colour images along with reduction by three times of the number of display elements and exclusion of colour filters, also requires the increase of frame frequency.

Therefore, the steady trend of development of stereoscopic display technology consists in increase (up to 480 Hz and more) of real frame frequency in order at observation of 3D images with the use of 3D glasses to exclude completely both flickering of observed image (peripheral vision is especially sensitive to it during long-term observation), and to increase dynamic 3D scenes reproduction smoothness.

The drawback of known 3D glasses during work with high (160-240 Hz and higher) switching frequency is the loss of quality of observed stereo image as the consequence of excessively high value of time τᵣₑₗₐₓ^{NLC}. In stereo image brightness spurious gradient occurs because the condition τᵣₑₗₐₓ≦τᵢₙₜ needed for its absence here is not satisfied. For example, at frame frequency of 480-500 Hz the time of frame scanning amounts about 2 ms, and the difference (τᵣₑₗₐₓ−τᵢₙₜ) for shutters of known 3D glasses amounts (3-1)=2 ms. It follows herefrom that the brightness gradient (variance) will capture the whole height of observed image (with minimum brightness of image at the top, in the beginning of scanning, and gradual increase up to maximum brightness at the bottom).

Another drawback of known 3D glasses is heavy energy consumption, as far as at operation with the use of low-voltage (3V) batteries the voltage up-converter (from 3 to 12-20V) is demanded for provision of required level of control voltage at shutters, and the value of energy consumption is directly proportional to squared value of voltage.

### Essence of Invention

The task solved in the invention is the improvement of quality of stereo image observed by means of 3D glasses during reduction of their energy consumption.

In recent years are achieved promising results in creation of high-speed shutters on the basis of oriented layers of ferroelectric liquid crystals—FLC [5].

Formulated problem is solved in active liquid-crystal 3D glasses containing synchronization signal receiver, self-contained power supply, electronic driver and two LC shutters, electrical inputs, first and second of which are connected to first and second outputs of electronic driver, which input is connected to output of synchronization signal receiver, and output of self-contained power supply is connected with power outputs of synchronization signal receiver and electronic driver, herewith every LC shutter is made as sequentially optically coupled first linear polarizer, first transparent dielectric plate, liquid crystal layer, second transparent dielectric plate and second linear polarizer, the internal sides of first and second transparent dielectric plates are coated with first and second transparent electrodes, over which first and second transparent orienting anisotropic coatings are deposited, at least transparent dielectric coating is deposited over one of which, liquid crystal layer is made with the possibility of electrically induced change of its optical anisotropy, with that the liquid crystal is made ferroelectric with helix pitch p₀, FLC layer thickness d and boundary conditions for FLC defined with quadratic coefficient W_{Q} of energy of molecules anchoring FLC layer with boundary surface of dielectric coating or of orienting anisotropic coating, are chosen in compliance with physical condition K_{φ}q²˜W_{Q}/d, where K_{φ} is the elasticity modulus of FLC helix deformation over azimuth angle φ, and q is the wave vector of FLC helix deformation (similarly to q₀=2π/p₀−wave vector of undisturbed helix with helix pitch distance p₀), self-contained power supply is made as low-voltage battery, which outputs are directly connected to power outputs of electronic driver, electronic driver is made with limiting switching frequency corresponding to reaction time of ferroelectric shutter to voltage of low-voltage battery.

As compared to NLC layer in shutters of known 3D glasses the time characteristics of switching of known FLC layers are not less than by an order better [5], herewith the values of times of switching on and off are equally small, because every of them is equal to time τ_{react}^{FLC} of reaction of FLC layer to applied control voltage of corresponding sign (polarity). However, known FLC layers are characterized with high values of control voltage (not less than 5-10 V), what is stipulated with the necessity to spend essential portion of energy of control field for helix unwinding and transition of FLC layer to another energy state. It should correspond to required change of the polarization direction of light (initially given with the direction of the first linear polarizer axis) passing through FLC layer, in order to obtain required light intensity behind the second linear polarizer.

In every shutter of proposed 3D glasses in thin (less than 2 μm) FLC layer the helix in the absence of external electric field is deformed to compensate the binding energy of molecules of boundary FLC layers with every of adjacent surfaces of dielectric coating or orienting anisotropic coating. In compliance with physical condition (1) FLC helix partially unwinds even in the absence of external control field. By means of this an essential reduction of energy of external control field needed for switching of FLC cell into required optical state is achieved under application of control voltage to electrodes (to electric inputs of FLC shutter). Thus, as a result of satisfaction to condition (1) providing partial unwinding of FLC helix in the absence of electric field the control voltage for FLC shutter is essentially reduced without reduction of the maximal frequency of shutter switching.

Switching frequency is related to time of optical response to control electrical action, i.e. to FLC director reorientation speed. This speed in turn depends on what type of viscosity—rotational or shear viscosity—prevails, and thus is responsible for energy dissipation [6]. At frequencies up to 300 Hz director reorientation speed is stipulated with ordinary (rotational) viscosity, and at higher frequencies, higher than reverse time of Maxwell fluid relaxation, FLC starts behaving as amorphous solid, i.e. it deforms elastically. Then the shear viscosity is responsible for FLC director reorientation speed, and itself reorients at the expense of domain walls movement. Increasing the field tension causes increase of the speed of domain boundaries movement and essential reduction of response time, i.e. improvement of frequency characteristics of FLC-cell.

Actual technical result is the increase of limiting frequency of shutters switching up to value of about 8 kHz at the value of control alternating-sign voltage not more than 3 V and up to the value of about 3 kHz at control voltage not more than 1.5 V. Since limiting frequency of shutters switching defines in fact limiting frequency of switching of 3D glasses as a whole, thus the formulated task is solved at obtaining of specified technical result, i.e. the improvement of quality of observed stereo image is achieved at the expense of complete elimination of flickering and improvement of conditions of dynamic scenes observation at increase of limiting frequency of 3D glasses switching and at reduction of their energy consumption due to reduction of FLC-shutters control voltage down to values that are characteristic for low-voltage batteries (3-1.5 V), for example, lithium battery, alkaline cell, silver-zinc cell. Herewith the absence of voltage up-converter in electronic tract of 3D glasses additionally increases their energy efficiency, because efficiency coefficient of voltage up-converter in known 3D glasses does not exceed 75%.

In the first particular variant of the device implementation the transparent dielectric coating is deposited over internal surface of only one dielectric plate. The advantage of this particular variant of device implementation is the additional reduction of control voltage at the expense of elimination of energy barrier at one of two boundaries “dielectric FLC” present in the device, and improvement of conditions of helix partial unwinding in the absence of electric voltage applied to a cell.

In the second particular variant of the device implementation the thickness of FLC layer in light-transmitting cell is chosen within the interval of 1.3-1.8 μm dependently on exact value of FLC optical anisotropy (birefringence).

### BRIEF DESCRIPTION OF DRAWINGS FIGURES

In drawing are presented:

FIG. 1.—functional block diagram of 3D glasses.

FIG. 2.—cross-section of FLC shutter of 3D glasses.

FIG. 3—explanation of FLC layer structure and a character of light modulation in it.

FIG. 4—forms of periodic control voltage ±1.5 V at frequency of 1 kHz (at the top) and optical response of FLC-shutter (at the bottom) displayed on oscilloscope screen.

### EMBODIMENT OF INVENTION

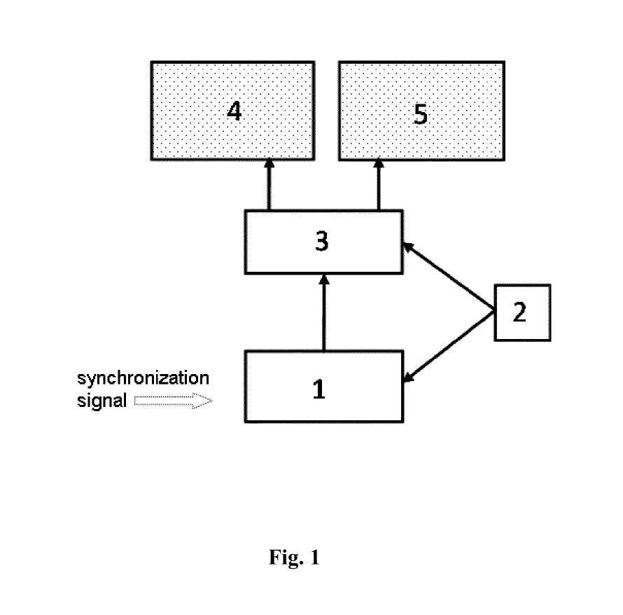

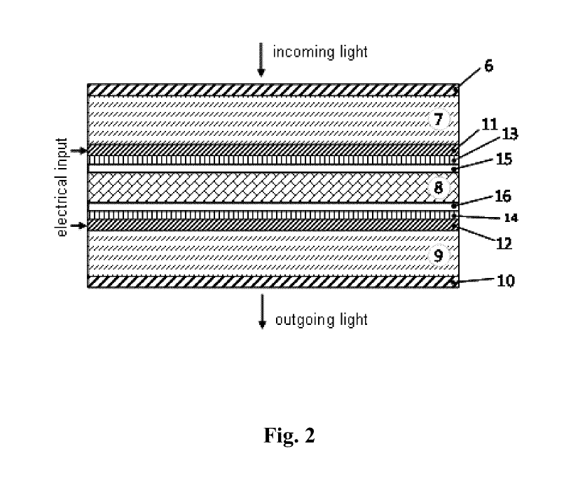

Active LC 3D glasses contain (FIG. 1) synchronization signal receiver 1, low-voltage battery 2, electronic driver 3, left 4 and right 5 ferroelectric liquid-crystal (FLC) shutters, output of low-voltage power source 2 is connected to power output of synchronization signal receiver 1 and power output of electronic driver 3, and every of FLC shutters 4, 5 contains (FIG. 2) first linear polarizer 6, first transparent dielectric (glass) plate 7, FLC layer 8 with thickness d, second dielectric (glass) plate 9 and second linear polarizer 10, herewith the internal sides of both dielectric plates 7, 9 are coated with transparent electrodes (transparent current-conducting coatings) 11, 12, over which transparent orienting anisotropic coatings 13, 14 are deposited, over which transparent dielectric coatings 15,16 (one of which may be absent) are deposited, and they are adjacent to boundary surfaces of FLC layer 8, boundary conditions for which are chosen according to the condition

K_{φ}q₀²˜W_{Q}/d, (1)

where K_{φ}, is the elasticity modulus of FLC helix deformation over azimuth angle φ;
q₀ is the wave vector of FLC helicoid deformation;
W_{Q}, is the energy of anchoring of FLC layer molecules with adjacent surface of dielectric coating or orienting anisotropic coating.

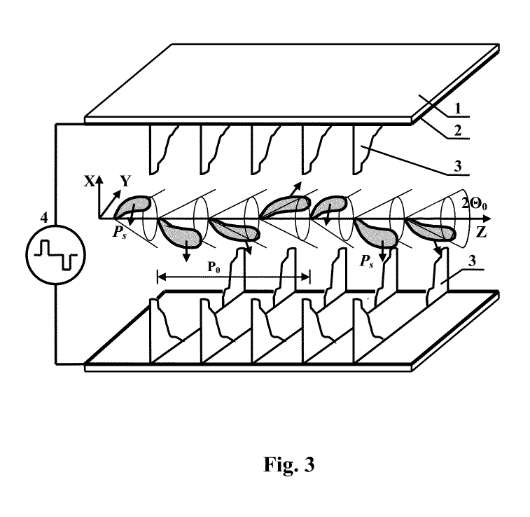

FLC layer (FIG. 3) represents multilayer twisted structure—a helix. Here between transparent dielectric plates 17 with transparent electrode coatings 18 smectic layers 19 are located, stipulated with periodic ordering of molecules mass centres along the direction of their long axes (director) orientation with period of the order of molecule length. Molecules possess dipole moment, which are perpendicular to their long axes, and FLC layer possesses spontaneous polarization P_{S}. In every layer the position of director is determined with polar angle θ₀ and azimuth angle φ that is changed from 0 to 2π at the distance equal to helix pitch distance p₀. Under action of electric field from source of alternating-sign voltage 20, applied parallel to smectic layers (along X-coordinate), vector P_{S} in all layers is oriented along field direction. As a consequence, helix unwinds. At sign change the field vector P_{c} is reoriented for 180°. In this case molecules long axes unfold over a cone surface with opening of θ₀, i.e. azimuth angle of the director orientation y is changed for 180⁰. Reorientation of director, which direction expressly defines the main optical axis of the ellipsoid FLC of refraction indexes, causes the change of angle between plane of polarization of incident light (light propagates along X-coordinate) and main optical axis of the ellipsoid, what means modulation of phase delay between ordinary and extraordinary rays, or modulation of light intensity, if electrooptic cell is between crossed polarizers.

At fulfilment of condition (1) and in the absence of applied electric field (E=0) helix partial unwinding occurs due to FLC molecules interaction with boundary layer, and at E>0 the reorientation of FLC molecules occurs due to domain walls movement. This promotes increase of FLC cell sensitivity to electric field action. The character of FLC molecules reorientation in electric field depends on what coefficient is responsible for energy dissipation in a layer—rotational or shear viscosity. At high frequencies of field (f), when τₘ·f<<1 (here τₘ is the time of Maxwell fluid relaxation), FLC starts behaving as amorphous solid, and it deforms elastically. Molecules reorient due to domain walls movement, and time of optical response defined with shear viscosity and speed of domain walls movement, reduces with frequency.

For many FLC compositions Δn≈0.17, and optimal thickness of layer that in its optical properties corresponds to half-wave plate for white light is equal to 1.4 μm. Advantage of the second particular variant of device implementation is obtaining of achromatic modulation characteristic—uniform for R-, G- and B-components of image in the case of use of 3D glasses for observation of colour stereo images.

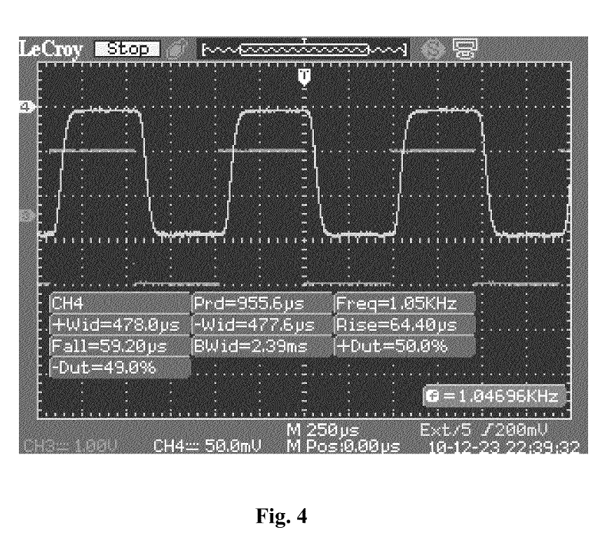

High speed of FLC shutter switching at low control voltage (±1.5 V at frequency of 1 kHz) is illustrated with FIG. 4. It is seen that transition time of optical response does not exceed 100 μs.

The device operates in the following way. Synchronization signal (IR-signal or radio signal, for example) comes to the input of synchronization signal receiver 1 that amplifies it to the values of logic signal coming to the input of electronic driver 3, that performs recognition and processing of information that is contained in synchronization signal (relating to a moment of beginning of every frame of image, reproduced at the display screen), and produces voltage of FLC shutters control that provides opening of left 4 (right 5) of them during the process of scanning of image of left (right) aspect angle of 3D scene reproduced on display screen. Observer provided with 3D glasses alternatively observes left and right image, light fluxes of which respectively come into left and right eye, what on account of binocular properties of vision leads to perception by observer of three-dimensional (stereoscopic) image of reproduced 3D scene. Power supply of receiver 1 and electronic driver 3 is provided directly from low-voltage battery 2. In particular, use of 3 V lithium cell of CR2032 type is sufficient for obtaining of 3D glasses switching limiting frequency of several kilohertz. Herewith the stabilization of supply voltage of given lithium cell is not required due to its sufficiently flat discharge characteristic minimum voltage at the end of operation life amounts about 2.5 V, at which all units of 3D glasses ensure the safe operation almost without loss of performance that is provided with a new battery.

3D glasses switching speed (speed of change of aspect angles of images at a screen) is chosen sufficiently high for complete elimination of flickering of observed image and provision of required degree of correctness (smoothness) of dynamic scenes reproduction, and reduced energy consumption of 3D glasses provides long battery life.

### INDUSTRIAL APPLICABILITY

Proposed active liquid-crystal 3D glasses with FLC shutters are low-voltage, fast-response, and are characterized with low energy consumption, working within the temperature range that corresponds to normal operating conditions, herewith the technology of such cell production is similar to well-proven technology of NLC-shutters, what promotes effective application of invention for three-dimensional full-colour displaying.

Particular example of invention embodiment

For embodiment of proposed invention several experimental samples of optical shutters liquid crystal modulators were manufactured, and their characteristics were measured.

A size of modulator FLC cell was equal to 50×35 mm, i.e. it amounted about 17 sq. cm. The standard 3-volts lithium battery CR2032 was used for power supply.

FLC layers with liquid-crystal phase within the interval from +1° C. to +64° C. were used, spontaneous polarization was equal to 48 nC/cm², rotational viscosity coefficient—0.75 Poise, and helix pitch—0.45 μm. According to [7], FLC elastic energy can be defined from the following correlation:

Wₑₗ=(K_{φ}q²)/2=Pₛ²/4χₛₜθ², (2)

where χₛₜ is the static value of dielectric susceptibility, θ is the slope angle of molecules in smectic layers. In the considered case χₛₜ=70, angle θ=23° (or 0.4025 rad), and the value of K_{φ}q₀² amounts about 900 erg/cm³.

The polyimide film with thickness of the order of 30 nm was made by means of centrifuging. It was rubbed and used as transparent anisotropic orientating coating. The aluminium dioxide film with thickness of 80 nm made by means of deposition was used as dielectric coating.

For planar orientation of FLC director (FIG. 1a) the quadratic coefficient of anchoring energy amounted W_{Q}=0.05 erg/cm². FLC layer thickness was 1.5 μm, what gave for W_{Q}/d the value of about 770 erg/cm² and satisfied to the correlation (2) with accuracy up to order of magnitude for specified energy types.

Interaction of molecules with the surface caused helix partial unwinding. Helix pitch in electrooptic cell didn't change, but the azimuth angle co in all the smectic layers became close to 0 or π. As the result, the FLC was divided into domains with the period of the order of p₀/2. For FLC with helix pitch p₀˜0.45 μm partial unwinding of helix structure occurred at FLC layer thickness d=1.5 μm.

When transparent conducting coating was screened with a dielectric layer on one of the substrates of FLC cell, the difference of polar coefficients of anchoring energy for both substrates, influencing the speed of movement of domain boundaries, was increased almost three times (from 0.015 to 0.04 erg/cm²), whereby the time of the cell electrooptic response reduced more than three times already at the field change frequency of the order of 200 Hz. For electric field tension of 1 V/μm the time of electrooptic response amounted 50÷70 μs.

Light transmission observed experimentally through crossed polarizers in a modulator on the basis of FLC cell with one side dielectric coating at pulse control voltage of ±1.5 V is modulated up to 600 Hz and does not show hysteresis at these frequencies and herewith modulation characteristic is similar to one for cells on the basis of nematic LC. At control with pulses of ±3.0 V the same modulation characteristic is observed at frequency up to 1500 Hz.

Low-voltage electronic part of 3D glasses is made on the basis of micro-consumption components electronic driver on the basis of programmable microcontroller of 430 series by Texas Instruments (USA) with supply voltage of 1.8-3 V, synchronization signal receiver—on the basis of micro-consumption operational amplifiers MIC863 by Micrel (USA) with supply voltage of 1.1-3 V. Lithium cell CR2032 with voltage of 3 V is used as low-voltage battery. It is possible to use connected in series 1.5-volts alkaline or silver-zinc cells or their rechargeable analogues (accumulators).

Thus, the considered example of invention embodiment confirms obtaining of alleged technical results and solution of problem formulated in invention.

### LITERATURE

1. B. MacNaughton, R. W. Kimmell, D. W. Allen. 3D glasses. USA Patent Application Publications, Pub. No. US 2010/0177254 A1 (Jul. 15, 2010).
2. Deng-Ke Yang, Shin-Tson Wu. Fundamentals of liquid crystal devices. John Wiley and Sons, 2006, pp. 199-242.
3. K. Kawahara. Liquid crystal panel, video display device and video display method. US Patent Application Publication No. US 2010/0066661, publ. 18.03.2010.
4. H. Hasegawa, N. Isobe. Three dimensional image system. US Patent Application Publication No. US 2010/0091207, publ. 15.04.2010.
5. Chigrinov V. G. Liquid Crystal Devices: Physics and Applications. Artech House Publishers,

London, 359 p. (1999).
6. L. D. Landau, E. M. Lifshits. “Theory of Elasticity”. Nauka, Moscow, 188-189, (1987).
7. A. L. Andreev, E. P. Pozhidaev, I. N. Kompanets, T. B. Fedosenkova, V. Ya. Zyryanov, S. L. Sorgon, T. Weyrauch, W. Haase. Saturation voltage and elastic energy of polymer dispersed ferroelectric liquid crystal films. Ferroelectrics, v. 243, 189-196 (2000).

1. Active liquid-crystal 3D glasses, containing synchronization signal receiver, self-contained power supply, electronic driver and two liquid-crystal shutters, electrical inputs, first and second of which are connected to first and second outputs of electronic driver, which input is connected to synchronization signal receiver output, and output of self-contained power supply is connected with power outputs of synchronization signal receiver and electronic driver, herewith every LC shutter is made as sequentially optically coupled first linear polarizer, first transparent dielectric plate, liquid crystal layer, second transparent dielectric plate and second linear polarizer, the internal sides of first and second transparent dielectric plates are coated with first and second transparent electrodes, over which first and second transparent orienting anisotropic coatings are deposited, at least transparent dielectric coating is deposited over one of which, liquid crystal layer is made with the possibility of electrically induced change of its optical anisotropy, characterized in that liquid crystal is made ferroelectric with helix pitch p₀, thickness d of layer of ferroelectric liquid crystal and boundary conditions for it defined with quadratic coefficient W_{Q} of energy of molecules anchoring of layer of ferroelectric liquid crystal with boundary surface of dielectric coating or of orienting anisotropic coating, are chosen in compliance with physical condition K_{φ}q²˜W_{Q}/d, where K_{φ} is the elasticity modulus of ferroelectric liquid crystal helix deformation over azimuth angle φ, and q is the wave vector of ferroelectric liquid crystal helix deformation, self-contained power supply is made as low-voltage battery, which outputs are directly connected to power outputs of electronic driver, electronic driver is made with limiting switching frequency corresponding to reaction time of ferroelectric shutter to voltage of low-voltage battery.

2. Active liquid-crystal 3D glasses according to clause 1, characterized in that the thickness d of layer of ferroelectric liquid crystal is chosen within the interval of 1.3÷1.8 μm.

3. Active liquid-crystal 3D glasses according to clause 1, characterized in that dielectric coating is deposited only on one transparent anisotropic coating.

4. Active liquid-crystal 3D glasses according to clause 1, characterized in that low-voltage battery is made as one lithium battery, or at least as one 1.5 V alkaline cell, or at least as one 1.5 V silver-zinc cell.
